(19) United States
(12) Patent Application Publication
(10) Pub. No.: US 2023/0078893 A1
(43) Pub. Date: Mar. 16, 2023

(54) INFORMATION PROCESSING DEVICE

(71) Applicant: TOYOTA JIDOSHA KABUSHIKI KAISHA, Toyota-shi Aichi-ken (JP)

(72) Inventors: Masahiro Mori, Nisshin-shi Aichi-ken (JP); Hiroaki Takada, Nagoya-shi Aichi-ken (JP); Shinya Honda, Nagoya-shi Aichi-ken (JP)

(73) Assignee: TOYOTA JIDOSHA KABUSHIKI KAISHA, Toyota-shi Aichi-ken (JP)

(21) Appl. No.: 17/876,076

(22) Filed: Jul. 28, 2022

(30) Foreign Application Priority Data
Sep. 13, 2021 (JP) 2021-148670

(51) Int. Cl. G06F 9/345

(52) U.S. Cl. CPC G06F 9/345; G06F 2209/5011

(57) ABSTRACT

An information processing device used for a convolutional neural network includes a processor configured to acquire input data and process the input data by using a convolution layer that executes convolution processing and a pooling layer that executes pooling processing, in which the processor is configured to divide the acquired input data into processing areas having an overlapping area in which processing areas overlap and a non-overlapping area in which processing areas do not overlap, and the processor is configured to, when the processor executes processing of the input data in the processing area, execute the convolution processing or the pooling processing in the non-overlapping area, and execute the processing by reusing a processing result of the convolution processing or a processing result of the pooling processing in the overlapping area.

### CROSS-REFERENCE TO RELATED APPLICATION

This application claims priority to Japanese Patent Application No. 2021-148670 filed on Sep. 13, 2021, incorporated herein by reference in its entirety.

### BACKGROUND

### 1. Technical Field

The present disclosure relates to an information processing device using a convolutional neural network.

### 2. Description of Related Art

WO 2020-194465 discloses a neural network circuit in which a convolution operation is divided into a convolution operation in a spatial direction and a convolution operation in a channel direction and the convolution operations are executed individually. The neural network circuit has a 1×1 convolution operation circuit that executes convolution in the channel direction, an SRAM that stores an operation result of the 1×1 convolution operation circuit, and an N×N convolution operation circuit that executes convolution in the spatial direction with respect to the operation result stored in the SRAM. By storing the operation result of the 1×1 convolution operation circuit in the SRAM, the memory bottle neck of the N×N convolution operation circuit is avoided. The memory bottle neck means that the time for reading the data needed for one convolution operation from the memory exceeds the time for one convolution operation (see WO 2020-194465).

### SUMMARY

In a convolutional neural network (CNN), it is known that the processing amount (operation amount) of the information processing device becomes enormous because a large amount of repetitive matrix operations are executed. Further, the higher the execution frequency of inference by the CNN (classifying input data and inferring the result), the higher the precision of inference. Therefore, to execute inference with high precision by using the CNN, it is desirable to use a central processing unit (CPU) or a graphics processing unit (GPU) with high processing power.

In an embedded system and the like, from the viewpoint of cost reduction, the CPU having a lower processing power than the general-purpose CPU may be used. For example, in the embedded system mounted in a vehicle, there is a case where an execution cycle is set for each task, processing needs to be executed reliably in a short time, and the processing speed is limited. When the CNN is used in the CPU with a low processing power, it is desirable to increase the execution frequency of inference while the processing amount (calculation amount) is reduced.

The present disclosure provides an information processing device capable of increasing precision of inference although a processing amount (operation amount) of a convolutional neural network is relatively small.

An aspect according to the present disclosure relates to an information processing device used for a convolutional neural network. The information processing device includes a processor configured to acquire input data, and process the input data by using a convolution layer that executes convolution processing and a pooling layer that executes pooling processing. The processor is configured to divide the acquired input data into processing areas having an overlapping area in which processing areas overlap and a non-overlapping area in which processing areas do not overlap, and the processor is configured to, when the processor executes processing of the input data in the processing area, execute the convolution processing or the pooling processing in the non-overlapping area, and execute the processing by reusing a processing result of the convolution processing or a processing result of the pooling processing in the overlapping area.

According to the aspect, the processor divides the acquired input data into processing areas having an overlapping area in which the processing areas overlap and a non-overlapping area in which the processing areas do not overlap. Since the overlapping area is set in the processing areas, the execution frequency of inference of the input data is increased, and the inference precision can be improved. When the processor executes the processing of the input data in the processing area, the processor executes the processing by reusing a processing result of the convolution processing or a processing result of the pooling processing in the overlapping area. Since the processing result of the convolution processing or the processing result of the pooling processing is reused, the processing amount (operation amount) can be reduced.

In the above aspect, the input data may be time-series data, and the processor may be configured to divide the time-series data into the processing areas at a fixed interval, and divide the processing area to have the overlapping area and the non-overlapping area.

According to the aspect, since the time-series data can be input to the processor while the overlapping of the time-series data is allowed, the execution frequency of inference can be increased.

In the above aspect, the processor may be configured to execute the processing of the input data by using a plurality of processing layers including the convolution layer and the pooling layer in a preceding stage of a fully connected layer. The processor may be configured to sequentially execute the convolution processing or the pooling processing from a first layer to a final layer of the processing layers during processing of a first cycle. Then, the processor may be configured to, during processing of second and subsequent cycles of the processing, execute the convolution processing or the pooling processing in the non-overlapping area of a previous cycle and a current cycle from the first layer to the final layer, and execute the processing of the input data by reusing a processing result of the convolution processing in the previous cycle or a processing result of the pooling processing in the previous cycle in the overlapping area of the previous cycle and the current cycle.

According to the aspect, the processor is configured to sequentially execute the convolution processing or the pooling processing from the first layer to the final layer of the processing layers during processing of the first cycle because there is no previous cycle and there is no overlapping area. In processing of the second and subsequent cycles of the processing, the convolution processing or the pooling processing is sequentially executed in the non-overlapping area of the previous cycle and the current cycle from the first layer to the final layer. As a result, it becomes possible to sequentially execute the processing from the first layer to the final layer with respect to the input data, and there is no waiting time for the processing, so that the processing time can be shortened. In the overlapping area of the previous cycle and the current cycle, the processing amount (operation amount) can be reduced because the processing result of the convolution processing in the previous cycle or the processing result of the pooling processing in the previous cycle is reused.

In the above aspect, the final layer may create output data to be input to the fully connected layer. The processor may be configured to create the output data by reusing the processing result of the convolution processing in the previous cycle or the processing result of the pooling processing in the previous cycle in the overlapping area of the previous cycle and the current cycle. The processor may be configured to create the output data by sequentially executing the convolution processing or the pooling processing from the first layer to the final layer in the non-overlapping area of the previous cycle and the current cycle. Then, the processor may be configured to input the output data to the fully connected layer when all the output data in the processing area of the current cycle is created in the final layer.

According to the aspect, in the final layer that creates the output data to be input to the fully connected layer, the output data is created by reusing the processing result of the convolution processing in the previous cycle or the processing result of the pooling processing in the previous cycle in the overlapping area, and the output data is created by sequentially executing the convolution processing or the pooling processing from the first layer to the final layer in the non-overlapping area. Therefore, since the output data input to the fully connected layer can be created by reusing the processing result in the overlapping area, the processing amount can be reduced.

In the above aspect, the processor may be configured to sequentially execute the processing when data that is processable by a kernel is prepared in the non-overlapping area of the previous cycle and the current cycle.

According to the aspect, in the non-overlapping area, without waiting for all the data in the non-overlapping area to be prepared, the processing is sequentially executed when data corresponding to a size and the like of the kernel (filter) is prepared. As a result, the processing time can be shorted.

In the above aspect, the processor may be mounted in the vehicle. Since the information processing device of the present disclosure has a small processing amount (operation amount), the CNN can be used by using the CPU of an embedded system mounted in the vehicle.

According to the present disclosure, the information processing device capable of increasing precision of inference can be provided although the processing amount (operation amount) of the convolutional neural network is relatively small.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a configuration of an information processing device according to the present embodiment;

FIG. 2 is a diagram for illustrating a detailed configuration of a processing unit;

FIG. 3 is a graph illustrating a method of dividing input data in related art;

FIG. 4 is a graph illustrating a method of dividing input data in the present embodiment;

FIG. 5 is a diagram schematically illustrating a CNN processing (operation) in related art; and

FIG. 6 is a diagram schematically illustrating the CNN processing (operation) in the present embodiment.

### DETAILED DESCRIPTION OF EMBODIMENTS

Hereinafter, embodiments of the present disclosure will be described in detail with reference to the drawings. The same or corresponding parts in the drawings are designated by the same reference numerals, and the description thereof will not be repeated.

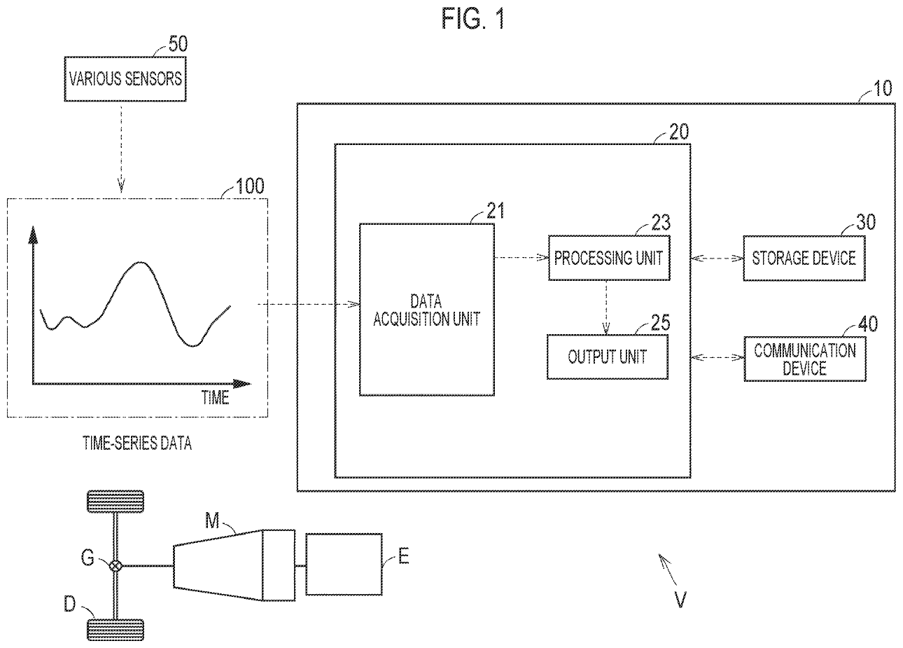

FIG. 1 is a diagram showing a configuration of an information processing device 10 according to the present embodiment. The information processing device 10 according to the present embodiment is mounted in a vehicle V. The vehicle V includes an internal combustion engine E, a transmission M, a differential gear G, and a drive wheel D. The vehicle V may be an electrified vehicle provided with an electric motor. The information processing device 10 executes inference by a convolutional neural network (CNN) (classifies input data and infers the result), and outputs the result. The information processing device 10 includes a processor 20, a storage device 30, and a communication device 40.

The storage device 30 is configured to include, for example, a read only memory (ROM) and a random access memory (RAM). The storage device 30 stores a program and the like executed by the processor 20. The communication device 40 is configured to allow bidirectional communication between an external device and the processor 20.

The processor 20 includes a data acquisition unit 21, a processing unit 23, and an output unit 25. The processor 20 functions as the data acquisition unit 21, the processing unit 23, and the output unit 25 by executing a program stored in the storage device 30. The processor 20 may include a buffer during processing data (input data) received from the data acquisition unit 21 by using the CNN, and may use the storage device 30 as the buffer.

The data acquisition unit 21 acquires time-series data 100 detected by various sensors 50 or created based on values detected by the various sensors 50. The time-series data 100 may be, for example, the motion state of the vehicle V (front-rear acceleration, lateral acceleration, vehicle speed, and the like), the rotation speed and the exhaust temperature of the internal combustion engine E, and the like, and may be time-series data related to the vehicle V. The data acquisition unit 21 acquires the time-series data 100 at a predetermined cycle, and outputs the acquired time-series data 100 to the processing unit 23.

The processing unit 23 processes the time-series data 100 (input data) received from the data acquisition unit 21 by using the CNN, and outputs the identification result (inference result) with respect to the input data to the output unit 25.

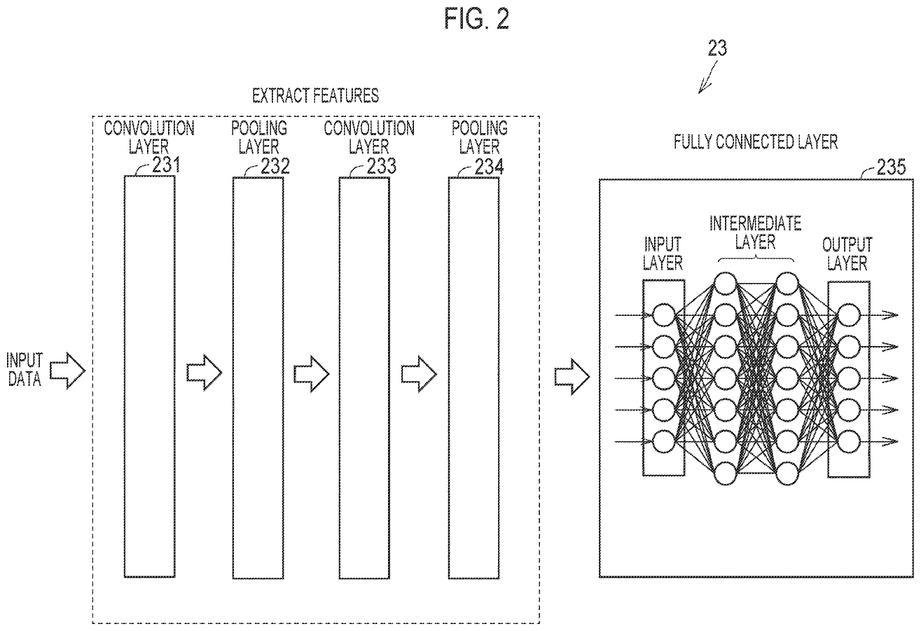

FIG. 2 is a diagram for illustrating a detailed configuration of the processing unit 23. The processing unit 23 includes convolution layers 231, 233, pooling layers 232, 234, and a fully connected layer 235. The convolution layers 231, 233 and the pooling layers 232, 234 extract features from the input data. In the convolution layers 231, 233, a convolution processing using a kernel (filter) of a predetermined size is executed. In the pooling layers 232, 234, processing that compresses the convolution result is executed, and the pooling processing is executed by using a kernel (window) of a predetermined size. In the present embodiment, MAX pooling is executed. Although FIG. 2 shows an example in which the two convolution layers 231, 233 and the two pooling layers 232, 234 are included in the processing unit 23, the number of the processing layers (the number of convolution layers and the number of pooling layers) can be changed as appropriate.

The fully connected layer 235 includes an input layer, an intermediate layer, and an output layer. The input layer is constituted with a plurality of units. The output of the pooling layer 234 converted into one dimension is input to each unit.

The intermediate layer is constituted with a plurality of layers. Although FIG. 2 shows a case where the number of layers of the intermediate layer is two, the number of layers of the intermediate layer can be changed as appropriate. Each layer of the intermediate layer is constituted with a plurality of units. Each unit is connected to each unit in the previous layer and each unit in the next layer. Each unit multiplies each output value from each unit in the previous layer by weight and integrates the multiplication results. Next, each unit adds (or subtracts) a predetermined bias to each of the integration results, inputs an addition results (or subtraction results) into a predetermined activation function (for example, a ramp function or a sigmoid function), and outputs the output value of the activation function to each unit of the next layer.

The output layer is constituted with one or more units. The number of units in the output layer can be changed as appropriate. Each unit in the output layer is connected to each unit of the final layer of the intermediate layer. Each unit of the output layer receives the output value from each unit of the final layer of the intermediate layer, multiplies each output value by weight, and integrates the multiplication results. The multiplication results are input to a predetermined activation function (for example, a ramp function or a sigmoid function). The output value of the activation function indicates, for example, a probability.

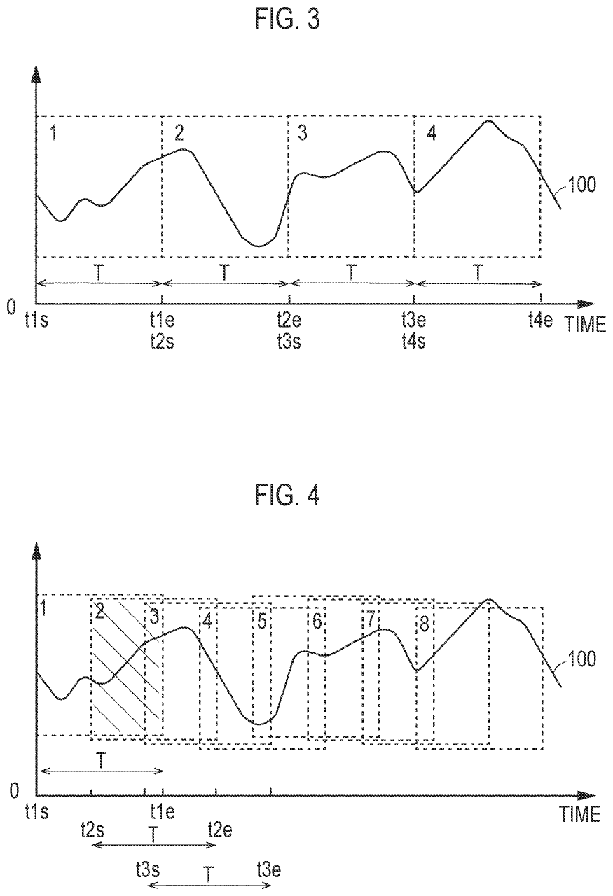

Generally, when the input data is the time-series data 100, in the processing using the CNN, the time-series data 100 (input data) acquired by the data acquisition unit 21 is divided at a fixed interval (fixed cycle), and as the processing area of the CNN (operation area), the first processing (processing of the convolution layer in the present embodiment) is executed. FIG. 3 is a graph illustrating a method of dividing input data in related art. As shown in FIG. 3, the time-series data 100 is divided by a fixed interval (fixed cycle) T, processing is executed with the time-series data 100 from time t1s to time t1e as a first processing area 1, and processing is executed with the time-series data 100 from time t2s (the same time as time t1e) to time t2e as a second processing area 2. The same applies to a third processing area 3 and a fourth processing area 4.

As described above, when the processing area is divided at the fixed interval T and processing of the CNN is executed, in a case where the time-series data 100 of which the feature is well represented exists between the first processing area 1 and the second processing area 2, there is a concern that the feature of the time-series data 100 cannot be inferred with good precision.

FIG. 4 is a graph illustrating a method of dividing input data in the present embodiment. In the present embodiment, as in the case in related art, when the time-series data 100 is divided at the fixed interval T, and the processing area is set, the overlapping of the processing areas is allowed and the overlapping area is set. As shown in FIG. 4, start time t2s of the second processing area 2 is set within the first processing area 1 from time t1s to time t1e, and the overlapping of the time-series data 100 from time t1s to time t1e is allowed. As a result, the time-series data 100 from time t2s to time t1e shown by the diagonal lines in FIG. 4 is an overlapping area of the first processing area 1 and the second processing area 2. Further, the time-series data 100 from time t1e to time t2e is a non-overlapping area in the second processing area 2. By setting start time t3s of the third processing area 3 within the second processing area 2 from time t2s to time t2e and allowing overlapping of the time-series data 100 from time t3s to time t2e, the time-series data 100 from time t3s to time t2e is an overlapping area of the second processing area 2 and the third processing area 3. After that, by similarly dividing the input data (the time-series data 100), an overlapping area in the processing area in the current cycle and the processing area in the previous cycle can be set.

Although FIG. 4 describes that the processing area is divided by time, the time-series data 100 is generated at each predetermined data collection interval. Dividing the time-series data 100 by the fixed interval (fixed cycle) T and setting a processing area are practically the same as setting the consecutive predetermined number of the time-series data 100 as processing areas. When the processing area of the consecutive predetermined number of the time-series data 100 is referred to as an “input window”, the overlapping area can be set by sliding the input window by the set number.

As described above, by allowing the overlapping of the processing areas in this way, since the area in which the time-series data 100 of which the feature is well represented exists can be reliably covered and the execution frequency of inference by the CNN can be increased, it is possible to infer the feature of the time-series data 100 with good precision. However, when inference by the CNN is executed for each processing area, there arises a problem that the processing amount (operation amount) increases.

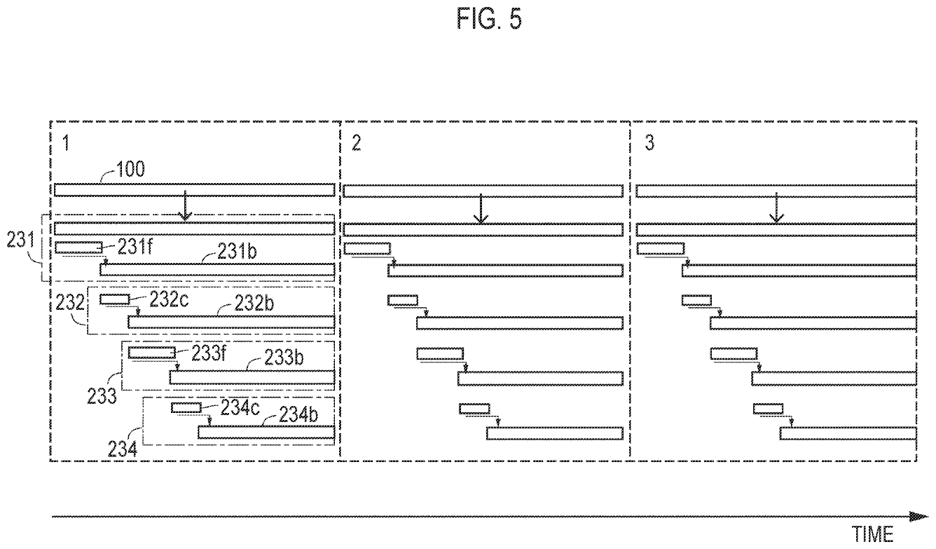

FIG. 5 is a diagram schematically illustrating the CNN processing (operation) in related art. In FIG. 5, the first layer of the processing layer is the convolution layer 231, the second layer is the pooling layer 232, the third layer is the convolution layer 233, and the final layer (fourth layer) is the pooling layer 234. The pooling layer 234, which is the final layer, creates output data to be input to the fully connected layer 235.

When the data acquisition unit 21 acquires the input data (the time-series data 100) and the time-series data 100 of the first processing area 1 is prepared, the first layer (the convolution layer 231) starts convolution processing by using a first layer kernel (filter) 231f. For example, a product-sum operation by using the first layer kernel 231f is executed while the first layer kernel 231f is sequentially slid, and the processing result (processing data) is stored in a first layer buffer 231b. When the processing of the first layer (the convolution layer 231) is completed, the processing of the second layer (the pooling layer 232) is executed.

In the second layer (the pooling layer 232), a second layer kernel (window) 232c is sequentially slid with respect to the processing data stored in the first layer buffer 231b to execute MAX pooling, and the processing result (processing data) is stored in a second layer buffer 232b. When the processing of the second layer (the pooling layer 232) is completed, the processing of the third layer (the convolution layer 233) is executed.

The processing of the third layer (the convolution layer 233) and the final layer (the pooling layer 234) is executed in the same manner as described above. Convolution processing by using a third layer kernel (filter) 233f is executed with respect to the processing data stored in the second layer buffer 232b, and the processing result is stored in a third layer buffer 233b. Further, MAX pooling by using a final layer kernel (window) 234c is executed with respect to the processing data stored in the third layer buffer 233b, and the processing result is stored in a final layer buffer 234b. Then, when the processing of the final layer (the pooling layer 234) is completed, the processing data stored in the final layer buffer 234b is input to the fully connected layer 235.

When the processing from the first layer (the convolution layer 231) to the final layer (the pooling layer 234) is completed in the first processing area 1, the same processing is executed in the second processing area 2. As described above, in related art, inference by the CNN is repeatedly executed sequentially for each processing area.

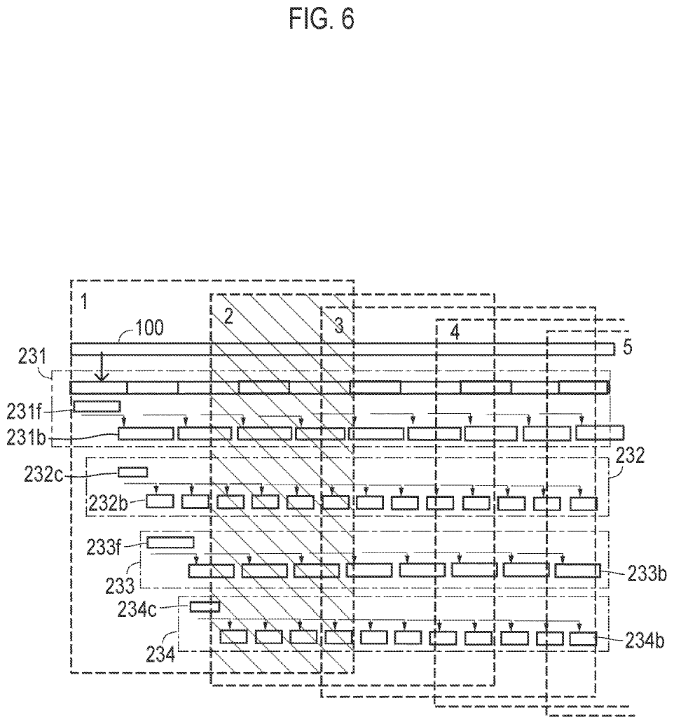

FIG. 6 is a diagram schematically illustrating the CNN processing (operation) in the present embodiment. In FIG. 6, as in FIG. 5, the first layer of the processing layer is the convolution layer 231, the second layer is the pooling layer 232, the third layer is the convolution layer 233, and the final layer (fourth layer) is the pooling layer 234. The pooling layer 234, which is the final layer, creates output data to be input to the fully connected layer 235.

In the present embodiment, in the processing of the first processing area 1, when the data acquisition unit 21 acquires the input data (the time-series data 100) in the first layer (the convolution layer 231), and the time-series data 100 capable of the product-sum operation using the first layer kernel (filter) 231f is prepared, convolution processing is started by using the first layer kernel 231f. For example, at first, when the same number (or the same number or more) of the time-series data 100 as the size of the first layer kernel 231f is prepared, the product-sum operation is executed, and the processing result (processing data) is stored in the first layer buffer 231b. In the next and subsequent processing (operation), when the time-series data 100 corresponding to the slide amount of the first layer kernel 231f is added, and the time-series data 100 capable of the product-sum operation using the first layer kernel 231f is prepared, the product-sum operation is executed, and the processing result (processing data) is stored in the first layer buffer 231b. As described above, in the first layer (the convolution layer 231), when the time-series data 100 capable of the product-sum operation using the first layer kernel 231f is prepared, the product-sum operation is sequentially executed, and the processing result (processing data) is stored in the first layer buffer 231b.

In the second layer (the pooling layer 232), the number of the processing data (the processing result of the first layer) stored in the first layer buffer 231b is the number that allows MAX pooling using the second layer kernel (window) 232c, the pooling processing is executed. For example, at first, when the same number (or the same number or more) of the processing data as the size of the second layer kernel 232c is prepared in the first layer buffer 231b, MAX pooling is executed, and the processing result (processing data) is stored in the second layer buffer 232b. In the next and subsequent processing (operation), when the processing data corresponding to the slide amount of the second layer kernel 232c is added to the first layer buffer 231b, and the processing data capable of MAX pooling using the second layer kernel 232c is prepared, MAX pooling is executed, and the processing result (processing data) is stored in the second layer buffer 232b. As described above, even in the second layer (the pooling layer 232), when the processing data capable of MAX pooling using the second layer kernel 232c is prepared in the first layer buffer 231b, the pooling processing is sequentially executed, and the processing result (processing data) is stored in the second layer buffer 232b.

The processing of the third layer (the convolution layer 233) and the final layer (the pooling layer 234) is also executed in the same manner as described above. When the processing data stored in the second layer buffer 232b is a state capable of convolution processing using the third layer kernel (filter) 233f, the convolution processing is sequentially executed, and the processing result is stored in the third layer buffer 233b. Further, when the processing data stored in the third layer buffer 233b is a state capable of MAX pooling using the final layer kernel 234c, the pooling processing is sequentially executed, and the processing result is stored in the final layer buffer 234b. Then, when the processing of the final layer (the pooling layer 234) in the first processing area 1 is completed, the processing data stored in the final layer buffer 234b is input to the fully connected layer 235.

In the non-overlapping area of the second processing area 2 (the second processing area following the overlapping area shown by diagonal lines in FIG. 6), the same processing as the processing in the first processing area 1 described above is executed with respect to the time-series data 100 in the non-overlapping area. As a result, the processing of the non-overlapping area of the second processing area is executed consecutively after the processing of the first processing area 1, and the processing result (processing data) with respect to the time-series data 100 in the non-overlapping area is stored in the final layer buffer 234b.

In the second processing area 2, in the overlapping area of the first processing area 1 and the second processing area 2 shown by the diagonal lines, the processing result of the first processing area 1 is reused. In the second processing area 2, the processing of the first layer (the convolution layer 231) to the final layer (the pooling layer 234) with respect to the time-series data 100 in the overlapping area is not executed, and the processing result of the first processing area 1 is reused by adding the processing result (processing data) processed (operated) in the first processing area 1 by using the time-series data 100 in the overlapping area and stored in the final layer buffer 234b to the processing result (processing data) with respect to the time-series data 100 in the non-overlapping area. When the processing of the second processing area 2 is completed, the processing result (processing data) processed (operated) in the first processing area 1 by using the time-series data 100 in the overlapping area, and the processing result (processing data) with respect to the time-series data 100 in the non-overlapping area are stored in the final layer buffer 234b, and thus the processing results (processing data) are input to the fully connected layer 235.

The processing of the third processing area 3 and after subsequent areas is executed in the same manner as the processing in the second processing area 2, and the processing result of the second processing area 2 is reused in the overlapping area of the second processing area 2 and the third processing area 3. In FIG. 6, there is an area in which the first processing area 1, the second processing area 2, and the third processing area overlap, and in the area, the processing result of the first processing area 1 is reused for the third processing area 3.

In the present embodiment, when the time-series data 100 (input data) acquired by the data acquisition unit 21 is divided at the fixed interval T and the processing area is set, the overlapping of the processing areas is allowed, and the overlapping area is set. By setting the overlapping area, since the area in which the time-series data 100 of which the feature is well represented exists can be reliably covered and the execution frequency of inference by the CNN can be increased, it is possible to infer the feature of the time-series data 100 with good precision.

In the present embodiment, when the processing in the processing area is executed, the processing result is reused in the overlapping area. That is, the processing result of the overlapping area of the previous cycle is output as the processing result of the overlapping area of the current cycle. As a result, the processing (operation) amount of the CNN can be reduced.

In the present embodiment, in the processing of the first processing area 1 that is the first cycle, the processing (operation) is sequentially executed from the first layer (the convolution layer 231) to the final layer (the pooling layer 234). During the processing of the second processing area 2 and subsequent areas, which is the processing of the second cycle and subsequent cycles, in the non-overlapping area of the previous cycle and the current cycle, the processing (operation) is executed from the first layer (the convolution layer 231) to the final layer (the pooling layer 234 is executed sequentially, and in the overlapping area of the previous cycle and the current cycle, the processing result of the previous cycle is reused. As a result, it is possible to sequentially execute the processing from the first layer to the final layer with respect to the time-series data 100 that is the input data, and there is no waiting time for the processing, so that the processing time can be shortened.

In the present embodiment, the final layer (the pooling layer 234) includes the final layer buffer 234b that stores the output data (processing data) input to the fully connected layer 235. The final layer buffer 234b stores the processing result (processing data) in the previous cycle in the overlapping area of the previous cycle and the current cycle, and stores the processing result (processing data) obtained by sequentially executing the processing from the first layer to the final layer in the non-overlapping area of the previous cycle and the current cycle. Then, when the processing in the processing area of the current cycle is completed, the processing data of the overlapping area and the processing data of the non-overlapping area stored in the final layer buffer 234b are input to the fully connected layer 235. As a result, the processing result (processing data) in the overlapping area is stored in the final layer buffer 234b that stores the output data (processing data) input to the fully connected layer 235 and reused, so that the processing amount (operation amount) can be reduced.

In the present embodiment, in the non-overlapping area, when the time-series data 100, the processing data stored in the first layer buffer 231b, the processing data stored in the second layer buffer 232b, and the processing data stored in the third layer buffer 233b is the number corresponding to the size of the corresponding kernel or the slide amount, and the data that can be processed by the kernel is prepared, the processing is executed. As a result, since the processing can be executed without waiting for all the data in the non-overlapping area to be prepared, the processing time can be shortened.

The embodiments disclosed this time should be considered to be exemplary and not restrictive in all respects. The scope of the present disclosure is set forth by the claims rather than the description of the embodiments, and is intended to include all modifications within the meaning and scope of the claims.

What is claimed is:

1. An information processing device used for a convolutional neural network, the information processing device comprising a processor configured to
acquire input data, and
process the input data by using a convolution layer that executes convolution processing and a pooling layer that executes pooling processing, wherein:
the processor is configured to divide the acquired input data into processing areas having an overlapping area in which processing areas overlap and a non-overlapping area in which processing areas do not overlap; and
the processor is configured to, when the processor executes processing of the input data in the processing area, execute the convolution processing or the pooling processing in the non-overlapping area, and execute the processing by reusing a processing result of the convolution processing or a processing result of the pooling processing in the overlapping area.

2. The information processing device according to claim 1, wherein:
the input data is time-series data; and
the processor is configured to divide the time-series data into the processing areas at a fixed interval, and divide the processing area to have the overlapping area and the non-overlapping area.

3. The information processing device according to claim 1, wherein:
the processor is configured to execute the processing of the input data by using a plurality of processing layers including the convolution layer and the pooling layer in a preceding stage of a fully connected layer;
the processor is configured to sequentially execute the convolution processing or the pooling processing from a first layer to a final layer of the processing layers during processing of a first cycle; and
the processor is configured to, during processing of second and subsequent cycles of the processing, execute the convolution processing or the pooling processing in the non-overlapping area of a previous cycle and a current cycle from the first layer to the final layer, and execute the processing of the input data by reusing a processing result of the convolution processing in the previous cycle or a processing result of the pooling processing in the previous cycle in the overlapping area of the previous cycle and the current cycle.

4. The information processing device according to claim 3, wherein:
the final layer creates output data to be input to the fully connected layer;
the processor is configured to create the output data by reusing the processing result of the convolution processing in the previous cycle or the processing result of the pooling processing in the previous cycle in the overlapping area of the previous cycle and the current cycle;
the processor is configured to create the output data by sequentially executing the convolution processing or the pooling processing from the first layer to the final layer in the non-overlapping area of the previous cycle and the current cycle; and
the processor is configured to input the output data to the fully connected layer when all the output data in the processing area of the current cycle is created in the final layer.

5. The information processing device according to claim 4, wherein the processor is configured to sequentially execute the processing when data that is processable by a kernel is prepared in the non-overlapping area of the previous cycle and the current cycle.

6. The information processing device according to claim 1, wherein the processor is mounted in a vehicle.
